(19) United States
(12) Patent Application Publication
(10) Pub. No.: US 2024/0332846 A1
(43) Pub. Date: Oct. 3, 2024

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: MU-JUNG HUANG, New Taipei City (TW); TSUNG-CHI CHEN, New Taipei City (TW)

(21) Appl. No.: 18/622,777

(22) Filed: Mar. 29, 2024

(30) Foreign Application Priority Data
Mar. 31, 2023 (TW) 112112734

(51) Int. Cl. H01R 13/50; H01R 13/56

(52) U.S. Cl. CPC H01R 13/501; H01R 13/567

(57) ABSTRACT

An electrical connector, wherein the electrical connector can offer sufficient wiring space for the accompanying conductive cables, thereby reducing the stacking height of the conductive cables during wiring to ensure that the electrical connector and its accompanying conductive cables occupy internal space within electronic devices at expected height dimensions. Additionally, the provided electrical connector can guide the conductive cables to extend outward laterally, enabling the conductive cables to extend laterally within electronic devices to facilitate the organization of conductive cables within electronic devices and even helps avoid unnecessary tangling of conductive cables within electronic devices, allowing electronic devices to continue advancing towards thinner designs.

### CROSS-REFERENCE TO RELATED APPLICATIONS

This application claims the priority of Republic of China Patent Application No. 112112734 filed on Mar. 31, 2023, in the State Intellectual Property Office of the R.O.C., the disclosure of which is incorporated herein by reference.

### BACKGROUND OF THE INVENTION

### Field of the Invention

This application relates to an electrical connector, more specifically, to an electrical connector capable of reducing the height dimensions of the internal space occupied within electronic devices.

### Descriptions of the Related Art

In modern electronic devices, electrical connectors are commonly installed. Generally, electrical connectors are equipped with conductive cables to provide power or transmit electrical signals within electronic devices. With the trend towards thinner electronic devices, the height dimensions of the internal space occupied by electrical connectors and conductive cables are constrained.

Given this, how to ensure that the height dimensions of the internal space occupied by electrical connectors and conductive cables meet expectations, thereby allowing electronic devices to continue advancing towards thinner designs, has become a pressing technical challenge in the industry.

### SUMMARY OF THE INVENTION

In view of the drawbacks of the prior art mentioned above, the present application provides an electrical connector. The electrical connector is equipped with a conductive component and a conductive cable assembly, wherein the conductive cable assembly includes an upper left conductive cable, an upper right conductive cable, a lower left conductive cable, and a lower right conductive cable, and the electrical connector comprises: an insulator, comprising an insulator body, an insulator joining structure, and an insulator outlet structure; the insulator body includes an insulator wiring space, an insulator joining side, and an insulator outlet side, and the insulator joining structure is located on the insulator joining side, while the insulator outlet structure is situated on the insulator outlet side; and a conductive terminal assembly, inserted into the insulator joining structure on the insulator joining side, and the conductive terminal assembly consists of a plurality of conductive terminals, wherein the plurality of conductive terminals respectively connect to the upper left conductive cable, the upper right conductive cable, the lower left conductive cable, and the lower right conductive cable, wherein the plurality of conductive terminals are arranged in a terminal arrangement area to facilitate to join with the conductive component; wherein the conductive cable assembly can be wired within the insulator wiring space to extend to the insulator outlet side, wherein the upper left conductive cable, the upper right conductive cable, the lower left conductive cable, and the lower right conductive cable are arranged in a cable outlet area, allowing the conductive cable assembly to extend outward through the insulator outlet structure; the terminal arrangement area is located on the insulator joining side, wherein the length of the terminal arrangement area is equal to the length of a terminal arrangement area; the cable outlet area is situated on the insulator outlet side, wherein the length of the cable outlet area is equal to the length of a cable outlet area; and the length of the terminal arrangement area and the length of the cable outlet area respectively are the length and width of the insulator wiring space, ensuring that the dimension of length and width of the insulator wiring space are sufficient to allow the conductive cable assembly to wire, reducing the stacking height of the upper left conductive cable, the upper right conductive cable, the lower left conductive cable, and the lower right conductive cable within the insulator wiring space, thus reducing the height of the insulator wiring space.

Preferably, the electrical connector said above, further comprising a cable clamping cover, which can be joined with the insulator, and the cable clamping cover comprises a cover cable clamping structure, when the cable clamping cover is joined with the insulator, the cover cable clamping structure is able to apply pressure to the upper left conductive cable, the upper right conductive cable, the lower left conductive cable, or the lower right conductive cable, ensuring that the adjacent ones of the upper left conductive cable, the upper right conductive cable, the lower left conductive cable, or the lower right conductive cable get closed tightly, thereby reducing the stacking height of the upper left conductive cable, the upper right conductive cable, the lower left conductive cable, and the lower right conductive cable within the insulator wiring space.

Preferably, the electrical connector said above, the insulator body further includes an insulator wiring guide structure, wherein the insulator wiring guide structure guides the wiring of the conductive cable assembly within the insulator wiring space; and the cable clamping cover further includes a cover wiring guide structure, wherein the cover wiring guide structure guides the wiring of the conductive cable assembly within the insulator wiring space.

Preferably, the electrical connector said above, wherein the cable outlet area includes a cable upper outlet sub-area and a cable lower outlet sub-area, wherein the upper left conductive cable and the upper right conductive cable are arranged in the cable upper outlet sub-area, while the lower left conductive cable and the lower right conductive cable are arranged in the cable lower outlet sub-area, and the cover cable clamping structure can press down on either the upper left conductive cable or the upper right conductive cable, allowing a portion of either the upper left conductive cable or the upper right conductive cable to enter the space of the cable lower outlet sub-area and snugly fit against the lower left conductive cable or the lower right conductive cable, allowing the portions of the cable upper outlet sub-area and the cable lower outlet sub-area to overlap, thereby reducing the dimension of height of the cable outlet area.

Preferably, the electrical connector said above, wherein the cable outlet area has a substantially parallelogram shape.

Preferably, the electrical connector said above, wherein the cable clamping cover further includes a cover cable management hole, and the cover cable management hole is in communication with the insulator wiring space, providing a means to organize the wiring of the conductive cable assembly within the insulator wiring space.

Preferably, the electrical connector said above, wherein the cable clamping cover further comprises a cover fastening structure, when the cable clamping cover is joined with the insulator, the cover fastening structure fastens the insulator, allowing the cable clamping cover and the insulator to form a unified structural body.

Preferably, the electrical connector said above, wherein the cable clamping cover further includes a cover wiring space, and the conductive cable assembly can wire in the cover wiring space and extends to the insulator outlet side.

Preferably, the electrical connector said above, wherein the cable clamping cover further includes a cover outlet structure, wherein the cover outlet structure is connected to the insulator outlet structure, allowing the conductive cable assembly to extend outward through the cover outlet structure.

Preferably, the electrical connector said above, wherein the cover outlet structure and the insulator outlet structure are through-hole structures.

Compared to prior art, the present application provides an electrical connector that can offer sufficient wiring space for the accompanying conductive cables, thereby reducing the stacking height of the conductive cables during wiring to ensure that the electrical connector and its accompanying conductive cables occupy internal space within electronic devices at expected height dimensions. Additionally, the provided electrical connector can guide the conductive cables to extend outward laterally, enabling the conductive cables to extend laterally within electronic devices to facilitate the organization of conductive cables within electronic devices and even helps avoid unnecessary tangling of conductive cables within electronic devices, allowing electronic devices to continue advancing towards thinner designs.

### BRIEF DESCRIPTION OF THE DRAWINGS

The above and other aspects, has and other advantages of the present invention will be more clearly understood from the following detailed description taken in conjunction with the accompanying drawings, in which:

FIG. 1 is a three-dimensional schematic diagram of the electrical connector viewed from a first angle according to an embodiment of the present application.

FIG. 2 is a three-dimensional schematic diagram of the electrical connector viewed from a second angle according to an embodiment of the present application.

FIG. 3 is a front view schematic diagram of an embodiment of the electrical connector according to the present application.

FIG. 4 is a rear view schematic diagram of an embodiment of the electrical connector according to the present application.

FIG. 5 is a top view schematic diagram of an embodiment of the electrical connector according to the present application.

FIG. 6 is a bottom view schematic diagram of an embodiment of the electrical connector according to the present application.

FIG. 7 is a side view schematic diagram of an embodiment of the electrical connector viewed from a first angle according to the present application.

FIG. 8 is a side view schematic diagram of an embodiment of the electrical connector viewed from a second angle according to the present application.

FIG. 9 is a three-dimensional schematic diagram of some components of the electrical connector viewed from a first angle according to an embodiment of the present application.

FIG. 10 is a three-dimensional schematic diagram of some components of the electrical connector viewed from a second angle according to an embodiment of the present application.

FIG. 11 is a three-dimensional schematic diagram of some components of the electrical connector viewed from a first angle according to an embodiment of the present application.

FIG. 12 is a three-dimensional schematic diagram of some components of the electrical connector viewed from a second angle according to an embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, structures or components with the same or similar functions in the following embodiments will be described using the same symbols, and descriptions of the same or equivalent technical features will be omitted to make the disclosed content more concise and easily understandable.

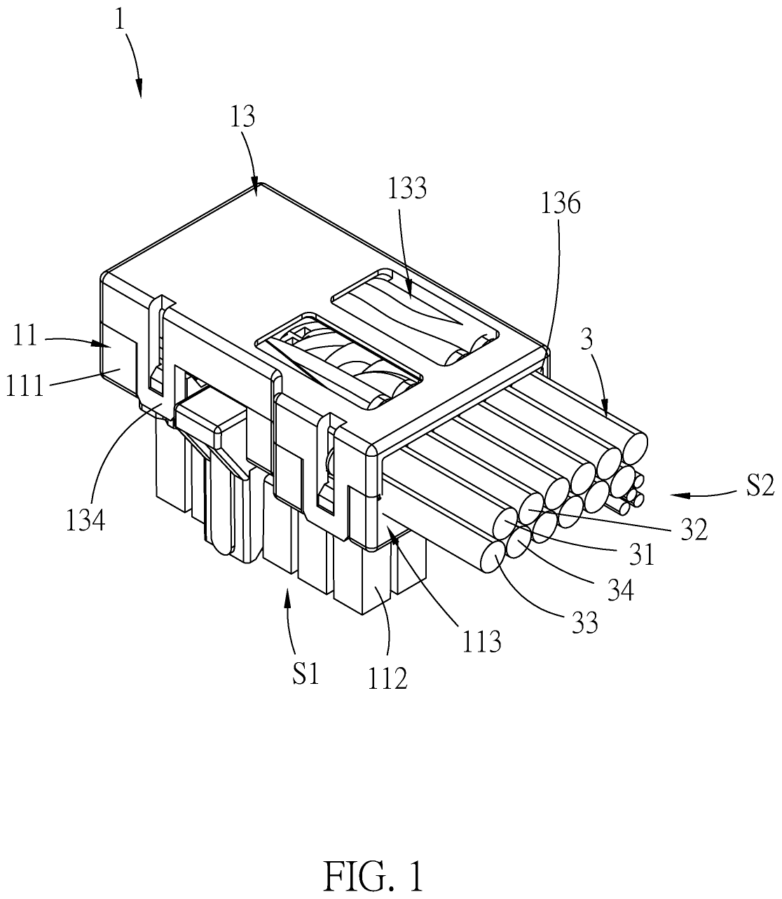

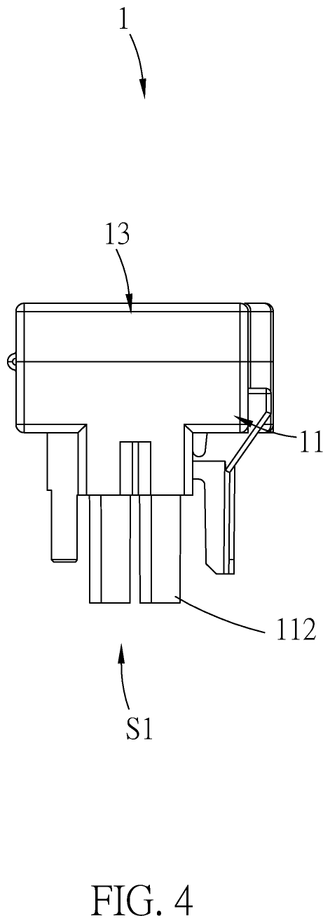

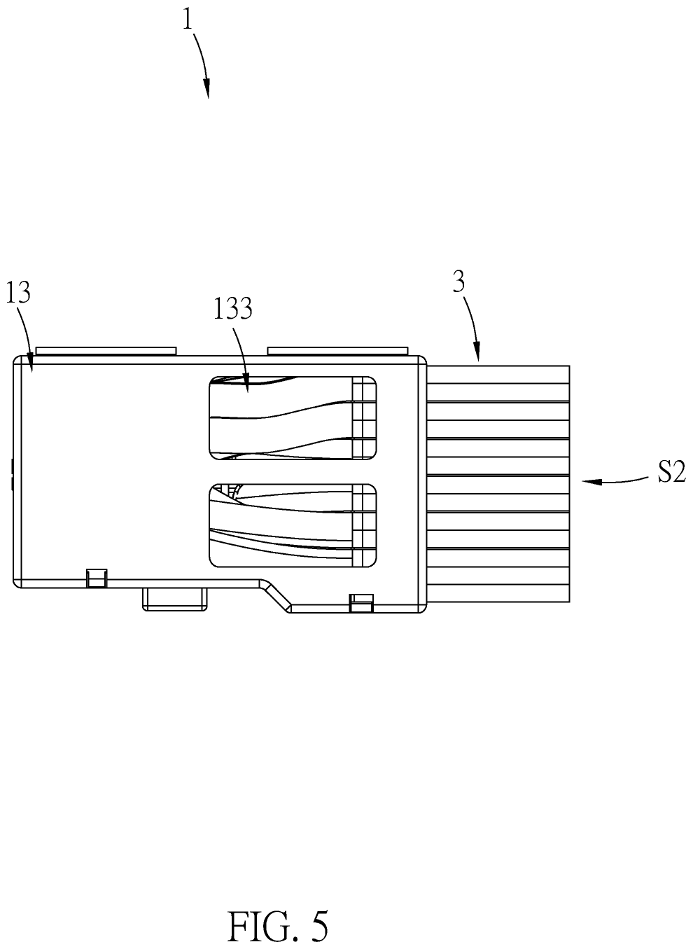

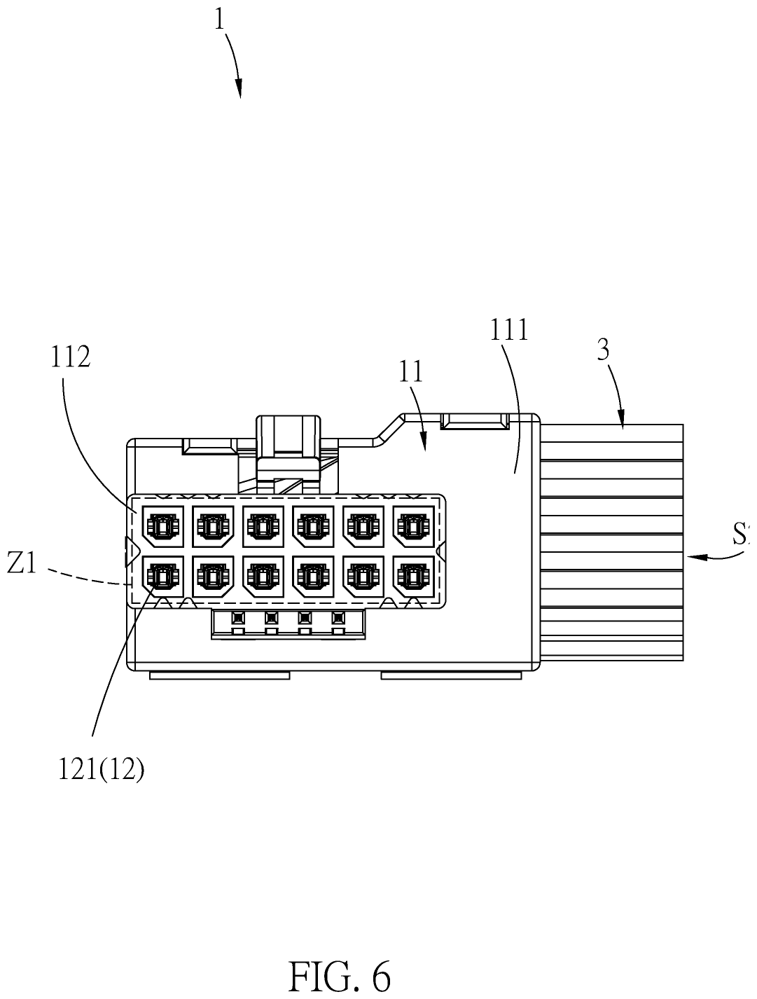

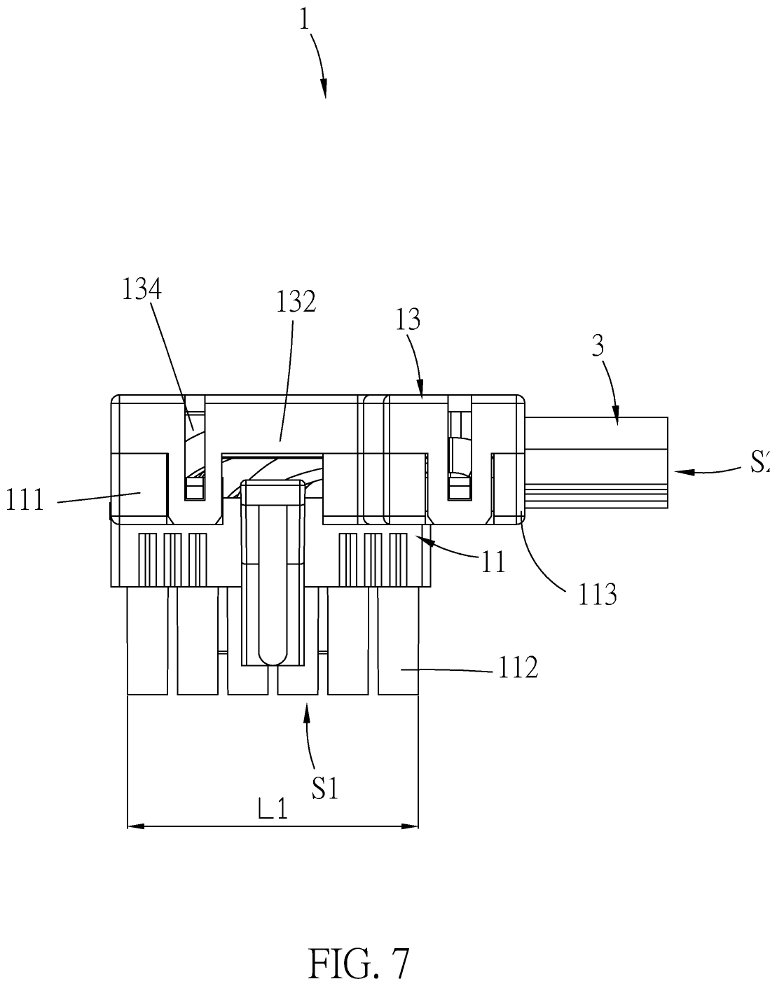

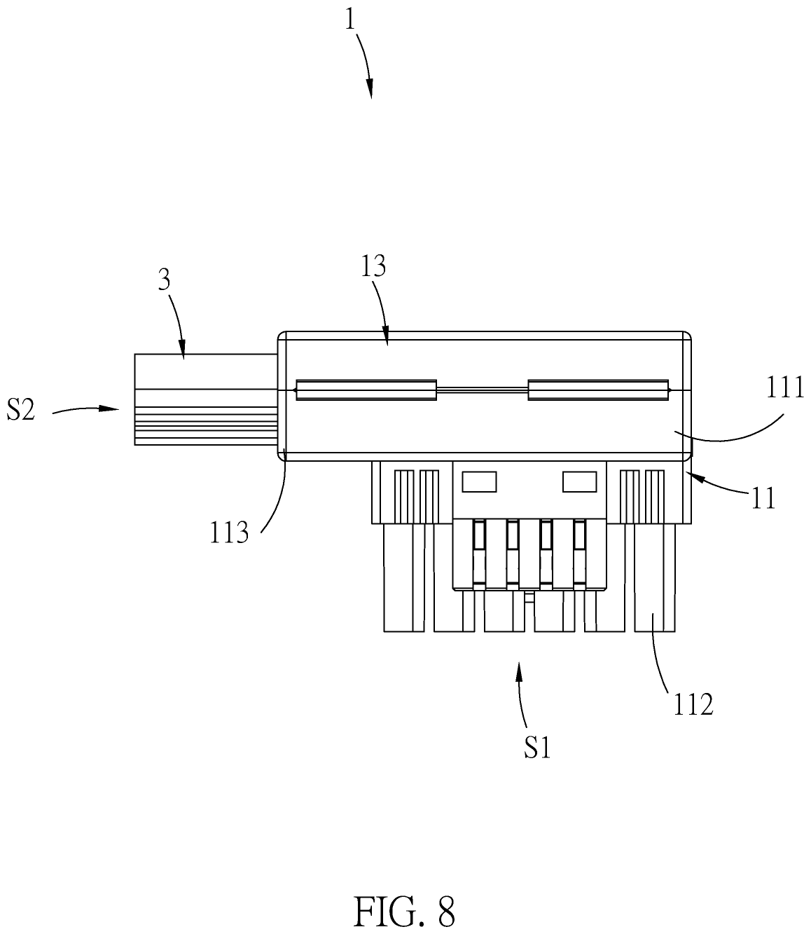

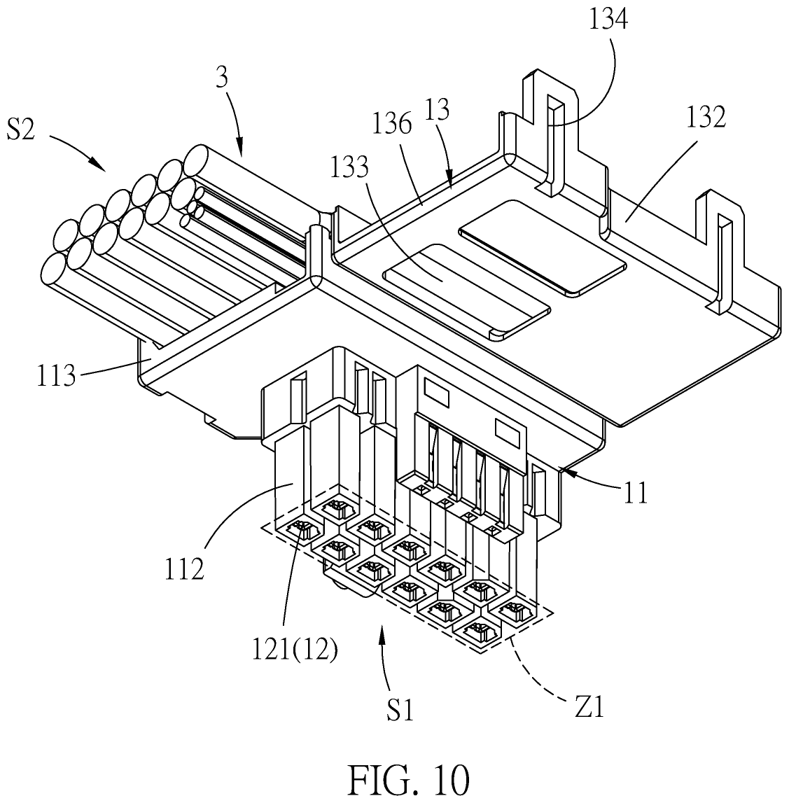

Regarding the technical concept of the present application, please refer to FIGS. 1 to 12.

In the embodiments shown in FIGS. 1 to 12, the electrical connector 1 is equipped with a conductive component 2 and a conductive cable assembly 3. The conductive component 2 refers to components capable of providing conductivity, such as electrical connectors or circuit boards. The conductive cable assembly 3 is composed of a plurality of conductive cables and can provide power or transmit electrical signals within electronic devices. As shown in FIGS. 1, 3, and 9, the conductive cable assembly 3 includes an upper left conductive cable 31, an upper right conductive cable 32, a lower left conductive cable 33, and a lower right conductive cable 34.

In the above embodiments, the electrical connector 1 comprises an insulator 11, a conductive terminal assembly 12, and a cable clamping cover 13. The insulator 11 comprises an insulator body 111, an insulator joining structure 112, and an insulator outlet structure 113. The insulator body 111 includes an insulator wiring space 1111, an insulator wiring guide structure 1112, an insulator joining side S1, and an insulator outlet side S2. It should be noted that the insulator joining structure 112 is located on the insulator joining side S1 of the insulator body 111, while the insulator outlet structure 113 is located on the insulator outlet side S2 of the insulator body 111.

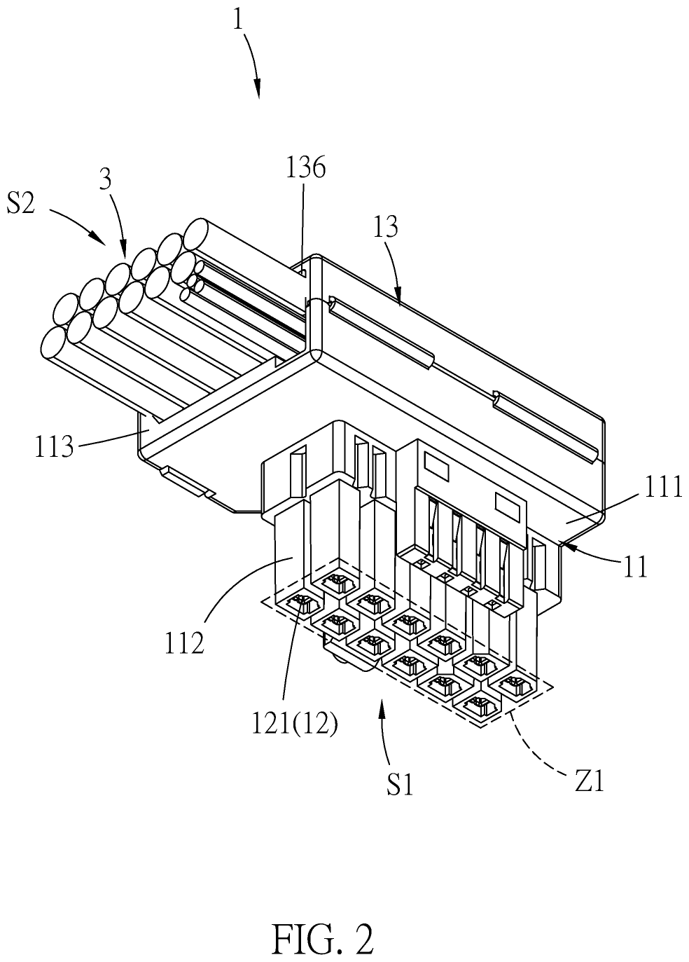

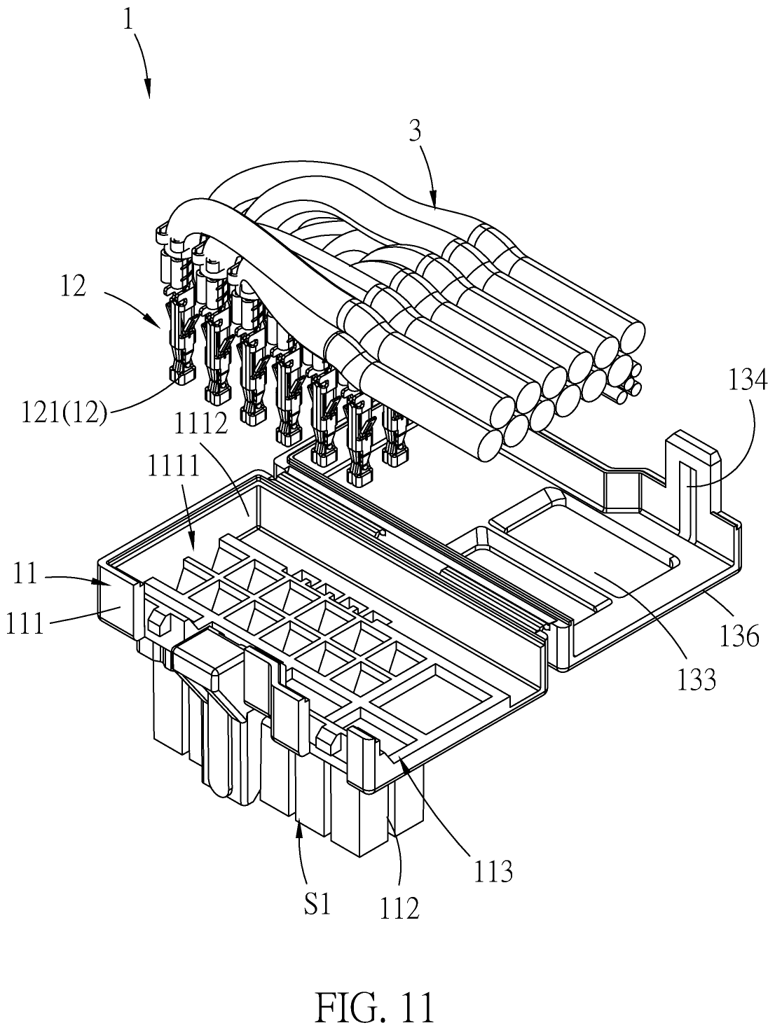

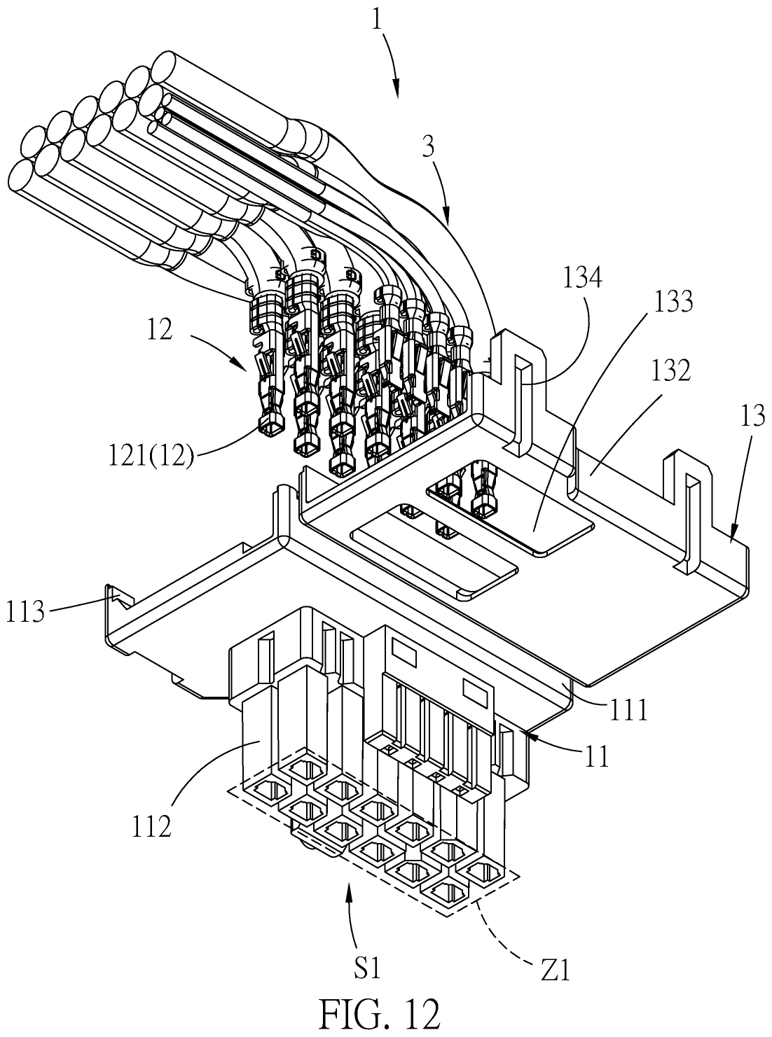

The conductive terminal assembly 12 is inserted into the insulator joining structure 112 on the insulator joining side S1 of the insulator body 111. As shown in FIGS. 11 to 12, the conductive terminal assembly 12 comprises a plurality of conductive terminals 121, and the plurality of conductive terminals 121 can respectively connect to the upper left conductive cable 31, the upper right conductive cable 32, the lower left conductive cable 33, and the lower right conductive cable 34 of the conductive cable assembly 3, providing power or transmitting electrical signals within electronic devices. It should be noted that, as shown in FIGS. 2, 10, and 12, the plurality of conductive terminals 121 are arranged in a terminal arrangement area Z1 and can be joined with the conductive component 2 via the insulator joining structure 112.

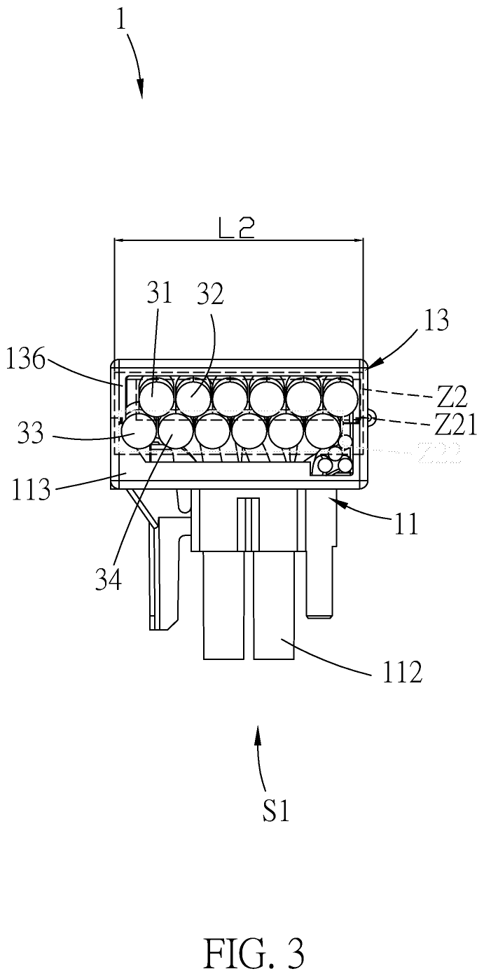

In the above embodiment, the insulator wiring guide structure 1112 is capable of guiding the conductive cable assembly 3 to wire within the insulator wiring space 1111, allowing the conductive cable assembly 3 to extend to the insulator outlet side S2 of the insulator body 111 within the insulator wiring space 1111. Additionally, as shown in FIG. 3, when the conductive cable assembly 3 extends to the insulator outlet side S2 of the insulator body 111, the upper left conductive cable 31, the upper right conductive cable 32, the lower left conductive cable 33, and the lower right conductive cable 34 are arranged in the cable outlet area Z2, allowing the conductive cable assembly 3 to extend outward through the insulator outlet structure 113. Therefore, the electrical connector 1 can guide the conductive cable assembly 3 to extend outward laterally, enabling the conductive cable assembly 3 to extend laterally within electronic devices, facilitating the organization of conductive cables within electronic devices and even helps avoid unnecessary tangling of conductive cables within electronic devices, allowing electronic devices to continue advancing towards thinner designs.

It should be noted that, in the above embodiment, the terminal arrangement area Z1 is located on the insulator joining side S1, and the length of the long side of the terminal arrangement area Z1 is the terminal arrangement area length L1. The cable outlet area Z2 is located on the insulator outlet side S2, and the length of the long side of the cable outlet area Z2 is the cable outlet area length L2.

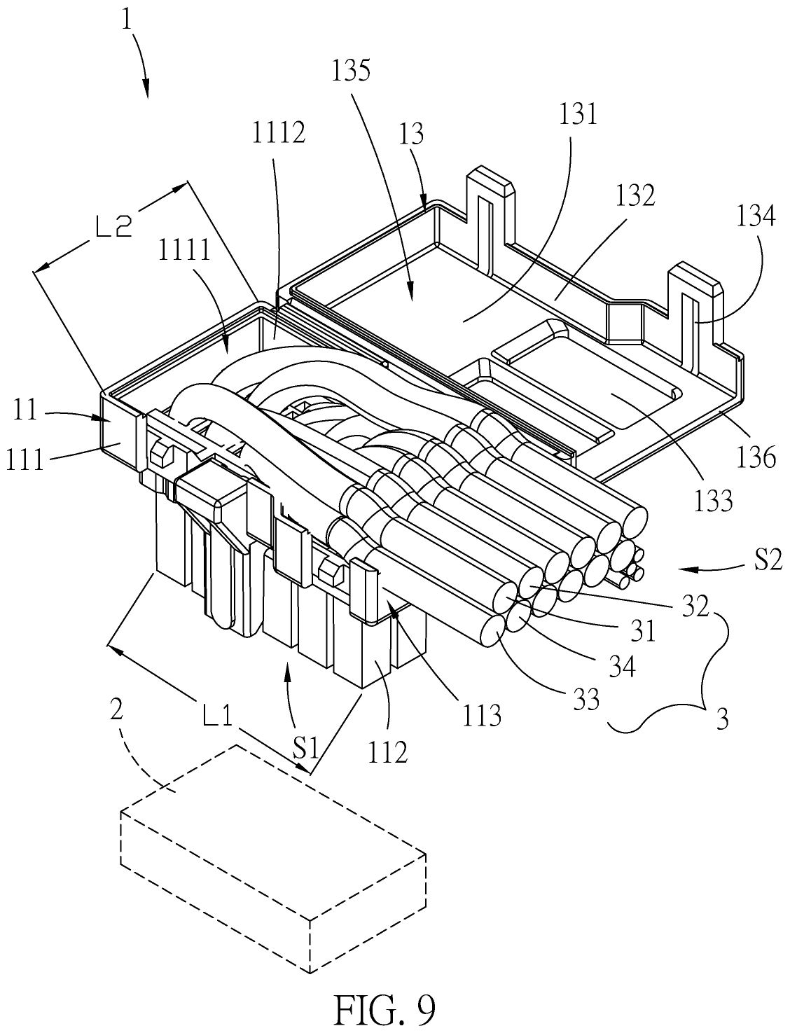

Additionally, as shown in FIG. 9, the terminal arrangement area length L1 and the cable outlet area length L2 are respectively the length and width of the insulator wiring space 1111, ensuring that the dimensions of the length and width of the insulator wiring space 1111 are sufficient to accommodate the wiring of the conductive cable assembly 3, thereby reducing the stacking height of the upper left conductive cable 31, the upper right conductive cable 32, the lower left conductive cable 33, and the lower right conductive cable 34 within the insulator wiring space 1111 and lowering the dimensions of the height of the insulator wiring space 1111.

The cable clamping cover 13 comprises a cover cable clamping structure 131, a cover wiring guide structure 132, a cover cable management hole 133, a cover fastening structure 134, a cover wiring space 135, and a cover outlet structure 136. In the aforementioned embodiment, the cover fastening structure 134 can be fastened to the insulator 11, allowing the cable clamping cover 13 to be joined to the insulator 11, forming a structure where the cable clamping cover 13 and the insulator 11 enable wiring of the conductive cable assembly 3 within. It should be noted that the cover wiring guide structure 132 is capable of guiding the conductive cable assembly 3 in wiring within the insulator wiring space 1111 or the cover wiring space 135, enabling the conductive cable assembly 3 to extend the insulator outlet side S2 of the insulator body 111.

In the above embodiment, when the cable clamping cover 13 is joined to the insulator 11, the cover cable clamping structure 131 can press down on the upper left conductive cable 31, the upper right conductive cable 32, the lower left conductive cable 33, or the lower right conductive cable 34, forcing the adjacent ones of the upper left conductive cable 31, the upper right conductive cable 32, the lower left conductive cable 33, or the lower right conductive cable 34 to get closed together, thereby reducing the stacking height of the upper left conductive cable 31, the upper right conductive cable 32, the lower left conductive cable 33, and the lower right conductive cable 34 within the insulator wiring space 1111. Thus, the electrical connector 1 and the equipped conductive cable assembly 3 can occupy the internal space of the electronic device with the expected height dimension, facilitating the continued development of electronic devices towards thinness.

In the embodiment shown in FIG. 3, the cable outlet area Z2 includes the cable upper outlet sub-area Z21 and the cable lower outlet sub-area Z22. It should be noted that the upper left conductive cable 31 and the upper right conductive cable 32 are arranged in the cable upper outlet sub-area Z21, while the lower left conductive cable 33 and the lower right conductive cable 34 are arranged in the cable lower outlet sub-area Z22. Therefore, when the cable clamping cover 13 is joined with the insulator 11, the cover cable clamping structure 131 can press down the upper left conductive cable 31 or the upper right conductive cable 32, forcing the upper left conductive cable 31 or the upper right conductive cable 32 to move so that a portion of the upper left conductive cable 31 or the upper right conductive cable 32 can enter the space of the cable lower outlet sub-area Z22 and be tightly adjacent to the lower left conductive cable 33 or the lower right conductive cable 34. In this way, a portion of the cable upper outlet sub-area Z21 and the cable lower outlet sub-area Z22 can overlap, giving the cable outlet area Z2 a substantially parallelogram shape, thereby reducing the height dimension of the cable outlet area Z2 to achieve the goal of reducing the height dimension of the internal space within electronic equipment occupied by the electrical connector 1 and the conductive cable assembly 3 equipped with the electrical connector 1.

It should be noted that when the cable clamping cover 13 is joined with the insulator 11, the cover cable management hole 133 is in communication with the insulator wiring space 1111, providing a wiring for organizing the conductive cable assembly 3 within the insulator wiring space 1111. The cover outlet structure 136 is in communication with the insulator outlet structure 113, allowing the cover outlet structure 136 to cooperate with the insulator outlet structure 113 to provide a lateral outlet for the conductive cable assembly 3. In other words, the conductive cable assembly 3 can also extend outward through the cover outlet structure 136. In the above-described embodiment, the cover outlet structure 136 and the insulator outlet structure 113 are through-hole structures.

It should be noted that the electrical connector provided in the present application can also omit the above-described features. For example, in the present application, the electrical connector comprises: an insulator and a conductive terminal assembly. The insulator comprises an insulator body, an insulator joining structure, and an insulator outlet structure. The insulator body comprises an insulator wiring space, an insulator joining side, and an insulator outlet side. The insulator joining structure is located on the insulator joining side, and the insulator outlet structure is located on the insulator outlet side. The conductive terminal assembly is inserted into the insulator joining structure on the insulator joining side, and the conductive terminal assembly includes a plurality of conductive terminals. The plurality of conductive terminals can respectively connect the upper left conductive cable, the upper right conductive cable, the lower left conductive cable, and the lower right conductive cable. The plurality of conductive terminals are arranged in a terminal arrangement area to facilitate connection with the conductive component. The conductive cable assembly can be wired through the insulator wiring space and extend to the insulator outlet side. The upper left conductive cable, the upper right conductive cable, the lower left conductive cable, and the lower right conductive cable are arranged in the cable outlet area, allowing the conductive cable assembly to extend outward through the insulator outlet structure. The terminal arrangement area is located on the insulator joining side, and the length of the terminal arrangement area is the terminal arrangement area length. The cable outlet area is located on the insulator outlet side, and the length of the cable outlet area is the cable outlet area length. The lengths of the terminal arrangement area and the cable outlet area are respectively the length and width of the insulator wiring space, ensuring that the dimensions of the insulator wiring space are sufficient to accommodate the wiring of the conductive cable assembly, thereby reducing the stacking height of the upper left conductive cable, the upper right conductive cable, the lower left conductive cable, and the lower right conductive cable within the insulator wiring space, thereby reducing the height dimension of the insulator wiring space.

In summary, the present application provides an electrical connector that can offer sufficient wiring space for the accompanying conductive cables, thereby reducing the stacking height of the conductive cables during wiring to ensure that the electrical connector and its accompanying conductive cables occupy internal space within electronic devices at expected height dimensions. Additionally, the provided electrical connector can guide the conductive cables to extend outward laterally, enabling the conductive cables to extend laterally within electronic devices to facilitate the organization of conductive cables within electronic devices and even helps avoid unnecessary tangling of conductive cables within electronic devices, allowing electronic devices to continue advancing towards thinner designs.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, equipped with a conductive component and a conductive cable assembly, wherein the conductive cable assembly includes an upper left conductive cable, an upper right conductive cable, a lower left conductive cable, and a lower right conductive cable, and the electrical connector comprises:
an insulator, comprising an insulator body, an insulator joining structure, and an insulator outlet structure; the insulator body includes an insulator wiring space, an insulator joining side, and an insulator outlet side, and the insulator joining structure is located on the insulator joining side, while the insulator outlet structure is situated on the insulator outlet side; and
a conductive terminal assembly, inserted into the insulator joining structure on the insulator joining side, and the conductive terminal assembly consists of a plurality of conductive terminals, wherein the plurality of conductive terminals respectively connect to the upper left conductive cable, the upper right conductive cable, the lower left conductive cable, and the lower right conductive cable, wherein the plurality of conductive terminals are arranged in a terminal arrangement area to facilitate to join with the conductive component; wherein
the conductive cable assembly can be wired within the insulator wiring space to extend to the insulator outlet side, wherein the upper left conductive cable, the upper right conductive cable, the lower left conductive cable, and the lower right conductive cable are arranged in a cable outlet area, allowing the conductive cable assembly to extend outward through the insulator outlet structure;
the terminal arrangement area is located on the insulator joining side, wherein the length of the terminal arrangement area is equal to the length of a terminal arrangement area;
the cable outlet area is situated on the insulator outlet side, wherein the length of the cable outlet area is equal to the length of a cable outlet area; and
the length of the terminal arrangement area and the length of the cable outlet area respectively are the length and width of the insulator wiring space, ensuring that the dimension of length and width of the insulator wiring space are sufficient to allow the conductive cable assembly to wire, reducing the stacking height of the upper left conductive cable, the upper right conductive cable, the lower left conductive cable, and the lower right conductive cable within the insulator wiring space, thus reducing the height of the insulator wiring space.

2. The electrical connector of claim 1, further comprising a cable clamping cover, which can be joined with the insulator, and the cable clamping cover comprises a cover cable clamping structure, when the cable clamping cover is joined with the insulator, the cover cable clamping structure is able to apply pressure to the upper left conductive cable, the upper right conductive cable, the lower left conductive cable, or the lower right conductive cable, ensuring that the adjacent ones of the upper left conductive cable, the upper right conductive cable, the lower left conductive cable, or the lower right conductive cable get closed tightly, thereby reducing the stacking height of the upper left conductive cable, the upper right conductive cable, the lower left conductive cable, and the lower right conductive cable within the insulator wiring space.

3. The electrical connector of claim 2, the insulator body further includes an insulator wiring guide structure, wherein the insulator wiring guide structure guides the wiring of the conductive cable assembly within the insulator wiring space; and the cable clamping cover further includes a cover wiring guide structure, wherein the cover wiring guide structure guides the wiring of the conductive cable assembly within the insulator wiring space.

4. The electrical connector of claim 2, wherein the cable outlet area includes a cable upper outlet sub-area and a cable lower outlet sub-area, wherein the upper left conductive cable and the upper right conductive cable are arranged in the cable upper outlet sub-area, while the lower left conductive cable and the lower right conductive cable are arranged in the cable lower outlet sub-area, and the cover cable clamping structure can press down on either the upper left conductive cable or the upper right conductive cable, allowing a portion of either the upper left conductive cable or the upper right conductive cable to enter the space of the cable lower outlet sub-area and snugly fit against the lower left conductive cable or the lower right conductive cable, allowing the portions of the cable upper outlet sub-area and the cable lower outlet sub-area to overlap, thereby reducing the dimension of height of the cable outlet area.

5. The electrical connector of claim 4, wherein the cable outlet area has a substantially parallelogram shape.

6. The electrical connector of claim 2, wherein the cable clamping cover further includes a cover cable management hole, and the cover cable management hole is in communication with the insulator wiring space, providing a means to organize the wiring of the conductive cable assembly within the insulator wiring space.

7. The electrical connector of claim 2, wherein the cable clamping cover further comprises a cover fastening structure, when the cable clamping cover is joined with the insulator, the cover fastening structure fastens the insulator, allowing the cable clamping cover and the insulator to form a unified structural body.

8. The electrical connector of claim 2, wherein the cable clamping cover further includes a cover wiring space, and the conductive cable assembly can wire in the cover wiring space and extends to the insulator outlet side.

9. The electrical connector of claim 2, the cable clamping cover further includes a cover outlet structure, wherein the cover outlet structure is connected to the insulator outlet structure, allowing the conductive cable assembly to extend outward through the cover outlet structure.

10. The electrical connector of claim 9, wherein the cover outlet structure and the insulator outlet structure are through-hole structures.
